(19) United States
(12) Patent Application Publication
(10) Pub. No.: US 2008/0196562 A1
(43) Pub. Date: Aug. 21, 2008

(54) Nut driver and method of making the same

(76) Inventors: Asif Elliston, Springfield, MA (US); Joseph T. Novak, East Longmeadow, MA (US); Peter Weremchuk, South Windsor, CT (US); Joseph J. Houle, East Hampton, MA (US)

Correspondence Address: MCCARTER & ENGLISH LLP;CITYPLACE I, 185 ASYLUM STREET, HARTFORD, CT, 06103, US

(21) Appl. No.: 11/707,428

(22) Filed: Feb. 16, 2007

(51) Int. Cl. B25B 31/00

(52) U.S. Cl. 81/433

(57) ABSTRACT

There is provided a device for driving a fastener, such as a nut driver, that includes an elongate shaft having a first end and a second end opposite the first end, an aperture disposed on the first end and having an interior aperture shape that is substantially the same as at least a portion of an exterior shape of the fastener, a handle disposed on the shaft, and a tactile feel element disposed on the shaft having an element shape. The element shape has an orientation that is at least substantially the same as an orientation of the interior aperture shape. There is also provided a manufacturing method.

### FIELD OF THE INVENTION

The invention relates to tools for driving fasteners such as nuts, bolts and screws, and more particularly to a nut driver or other tool that provides one or more visual and/or tactile feel elements to assist a user in determining the orientation of the device relative to a fastener, and methods to make such nut drivers or other tools.

### BACKGROUND OF THE INVENTION

Nut drivers, socket wrenches, and other tools are useful in securing nuts, bolts and other fasteners. Various features have been incorporated into such tools to ease their use. For example, visual indicators have been included on the handle of the tool to indicate the size or type of fastener for which the tool is compatible. In addition, indicators have been devised to assist users in orienting the nut driver with respect to the fastener or nut that the user wishes to engage. For example, nut drivers have been devised having a visual picture or indication of the fastener on the butt end of the handle, where the orientation of the pictured fastener coincides with the orientation of the socket that receives the fastener. With this feature, the user can potentially position the nut driver over the fastener with reduced trial and error, which would be particularly useful to technicians who use nut drivers on a frequent basis. Although the abovementioned feature is helpful, it presents the disadvantage that the user's hands cover the visual indication on the butt end of the handle during normal operation of the nut driver, thereby reducing the usefulness of the feature. Furthermore, the visual indication typically wears off over time or can become marred by dirt, paint, oil or other substances, which prevents the user from seeing the visual indication and makes it more difficult to orient the nut driver relative to a fastener or nut.

For the foregoing reasons, there is a need for a nut driver or other tool that provides a visible indicator that is unobstructed during normal use and/or a tactile feel indicator that allows the user to orient the nut driver relative to the fastener by feeling the indicator.

### SUMMARY OF THE INVENTION

One aspect of the present invention is directed to a device for driving a fastener, such as a nut driver, that includes an elongate shaft having a first end and a second end opposite the first end, an aperture disposed on the first end and having an interior aperture shape that is substantially the same as at least a portion of an exterior shape of the fastener, a handle disposed on the shaft, and a tactile feel element disposed on the shaft having an element shape. The element shape has an orientation that is at least substantially the same as an orientation of the interior aperture shape.

In another aspect of the invention, the interior aperture shape is a shape of the aperture in a plane perpendicular to an axis of rotation of the shaft, and the element shape is a shape of the tactile feel element in a plane perpendicular to the axis of rotation. The orientation of the interior aperture shape and the element shape is an angular position about the axis of rotation.

In yet another aspect of the invention, the interior aperture shape includes a plurality of corners and sides, and the element shape includes a plurality of corners and sides. The corners of the interior aperture shape have an angular position about the axis of rotation that is at least substantially equal to an angular position of the corners of the element shape about the axis of rotation. The element shape may be proportional to the interior aperture shape. The tactile feel element and the interior aperture may also be hexagonally shaped.

In a further aspect of the invention, the nut driver includes at least one magnet disposed in a socket head formed around the aperture so that a face of the magnet is located at or near a surface of the aperture. In another aspect, a first magnet is disposed in the socket head so that a face of the first magnet is located at or near a surface of a first side of the interior aperture shape, a second magnet is disposed in the socket head so that a face of the second magnet is located at or near a surface of a second side of the interior aperture shape, and the first side and the second side are not directly opposite each other.

Still another aspect of the invention is directed to a method of manufacturing a handle for a device for driving a fastener, including co-molding a first material defining a first color and forming at least a portion of an inner part of the handle, and a second material defining a second color and forming at least a portion of an outer part of the handle. At least one of the first and second colors is indicated by at least one of a size and a type of the device. The method may further include overmolding the second material and the outer part of the handle to the first material and the inner part of the handle.

The nut driver of present invention offers the advantage of providing the user with unobstructed visible and/or tactile feel elements that assist the user in determining the orientation of the nut driver and providing a more precise tool for engaging a fastener or nut.

These and other features, aspects and advantages of the present invention will become better understood with reference to the following description, appended claims and accompanying drawings.

### BRIEF DESCRIPTION OF THE DRAWINGS

FIG. 1 is a front perspective view of an embodiment of a nut driver according to the present invention;

FIG. 2 a rear perspective view of the nut driver of FIG. 1;

FIG. 3A is a side view of the nut driver of FIG. 1;

FIG. 3B is a close-up side view of a handle portion of the nut driver of FIG. 1;

FIG. 4A is a side perspective view of an embodiment of a shaft of the nut driver of FIG. 1;

FIG. 4B is a side view of the shaft of FIG. 4A;

FIG. 4C is a rear view of the shaft of FIG. 4A;

FIG. 5A is a side view of an interior portion of an embodiment of a handle shown in the nut driver of FIG. 1;

FIG. 5B is a front perspective view of the interior portion of FIG. 5A;

FIG. 5C is front view of the interior portion of FIG. 5A;

FIG. 6A is a front perspective exploded view of an embodiment of a handle shown in the nut driver of FIG. 1;

FIG. 6B is a side perspective view of the handle of FIG. 6A;

FIG. 6C is a side view of the handle of FIG. 6A; and

FIG. 7A is a perspective view of an alternative embodiment of the nut driver of FIG. 1.

FIG. 7B is a side view of the nut driver of FIG. 7A.

### DETAILED DESCRIPTION OF THE INVENTION

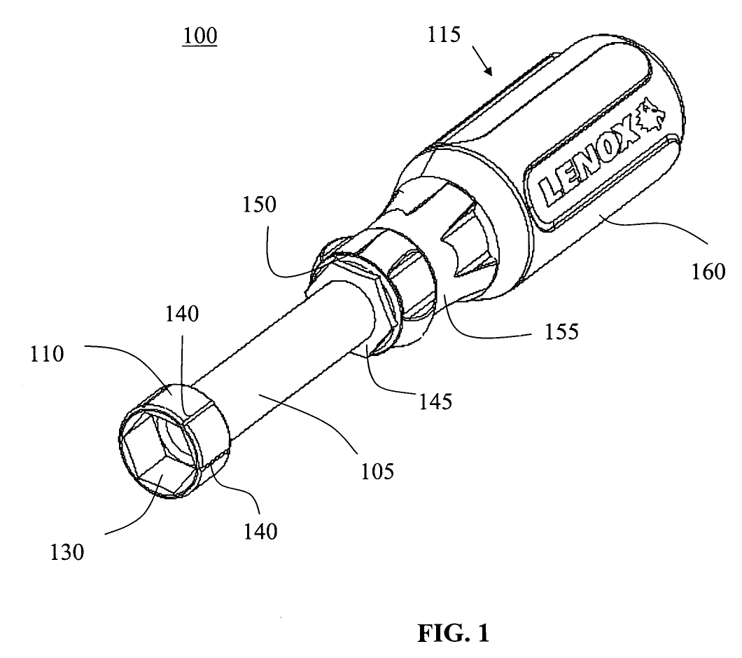

Referring to FIGS. 1-3, a nut driver embodying the present invention is indicated generally by the reference numeral 100. Nut driver 100 includes an elongated shaft 105. A driving portion 110, also referred to as a socket head, and a handle 115 are disposed at opposite ends of shaft 105.

Shaft 105 is preferably made from a metal or metal alloy, and may incorporate driving portion 110 as a portion having the same diameter as shaft 105. Driving portion may also have various larger diameters to accommodate nuts and fastener heads of various sizes, including those that are larger than shaft 105, as shown in FIGS. 1-3. In another embodiment, driving portion 110 is a separate metal component that is welded to one end of shaft 105.

Shaft 105 may also be hollow. In a preferred embodiment, both shaft 105 and driving portion are hollow to allow nut driver 100 to engage a nut located on a length of a threaded rod. This feature allows the threaded rod to be received within the hollow area so that driving portion 110 can engage and rotate the nut. In this embodiment, shaft 105 is preferably a cold formed, through hardened or case hardened metal, such as carbon steel.

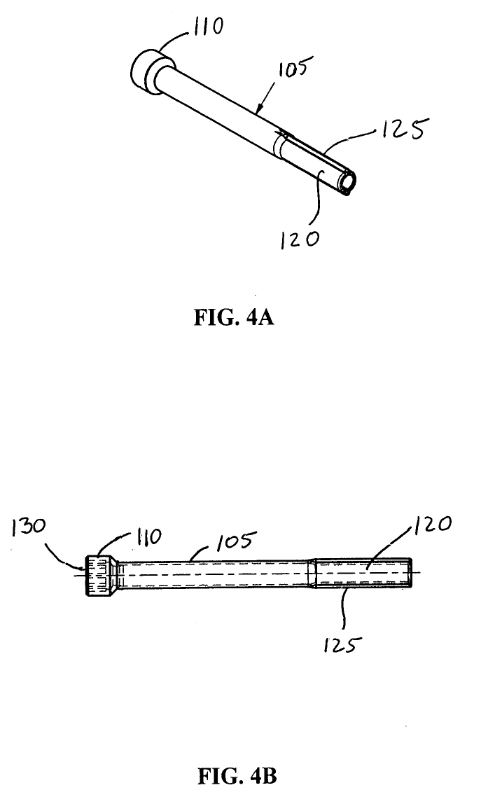

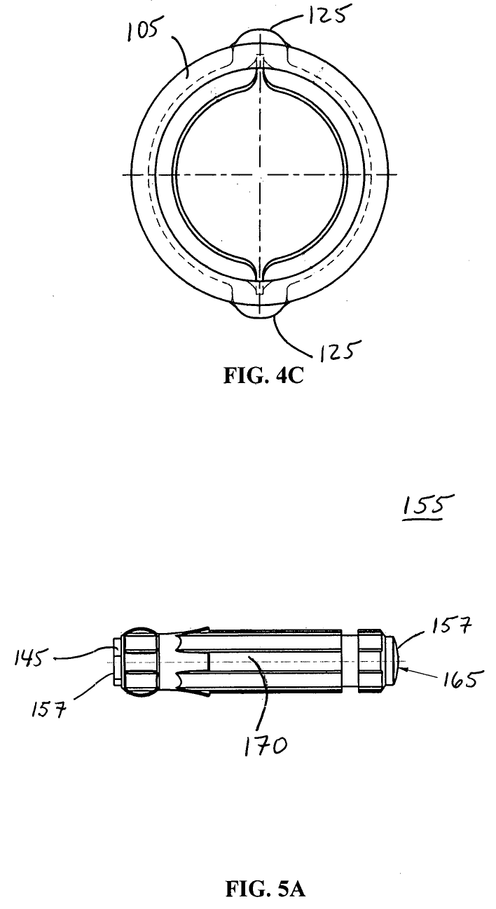

FIGS. 4A-4C show shaft 105 disassembled from the remainder of nut driver 100. Shaft 105 includes driving portion 110 at a first end of shaft 105 and a handle portion 120 located at an opposite second end of shaft 105. Handle portion 120 has any diameter sufficient to engage a hollow portion of handle 115 shown in FIG. 1. Handle portion 120 may include one or more guides 125, which are elongated protuberances designed to be received in one or more corresponding recesses in a hollow portion of handle 115. When handle 115 is engaged with shaft 105, guides 125 are received in the recesses. Guides 125 may be in the form of one or more protuberances of any desired shape. Handle 115 may be assembled over shaft 105 by forcing guides into handle 115 via press fitting. Handle 115 may also be overmolded to shaft 105, and preferably held in place by protuberances on shaft 105. These configurations substantially prevent any relative rotation of shaft 105 and handle 115 during use of nut driver 100. The shaft may have recesses, the handle may have protuberances, or the shaft and the handle may each have a combination of recesses and protuberances.

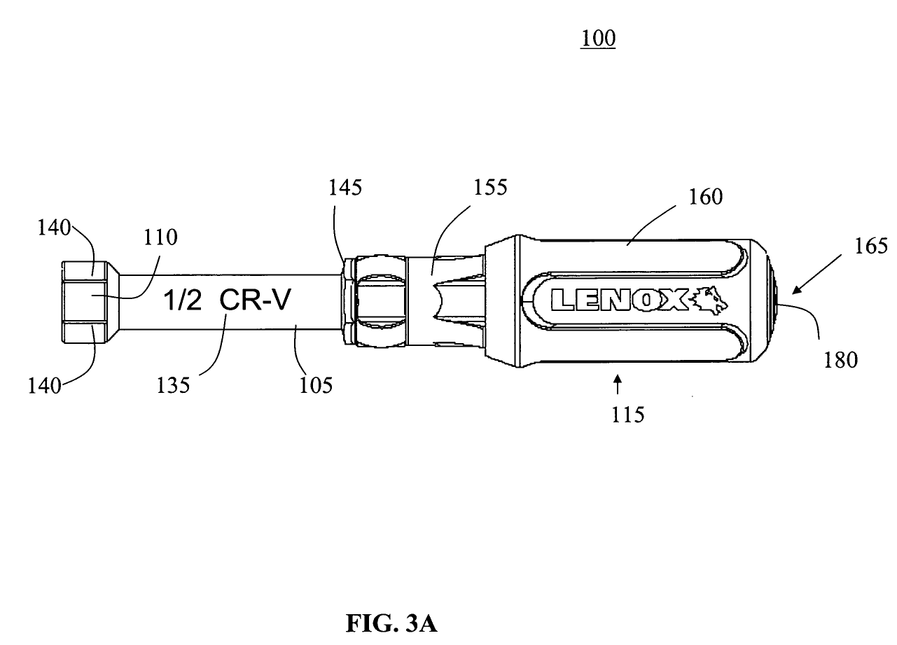

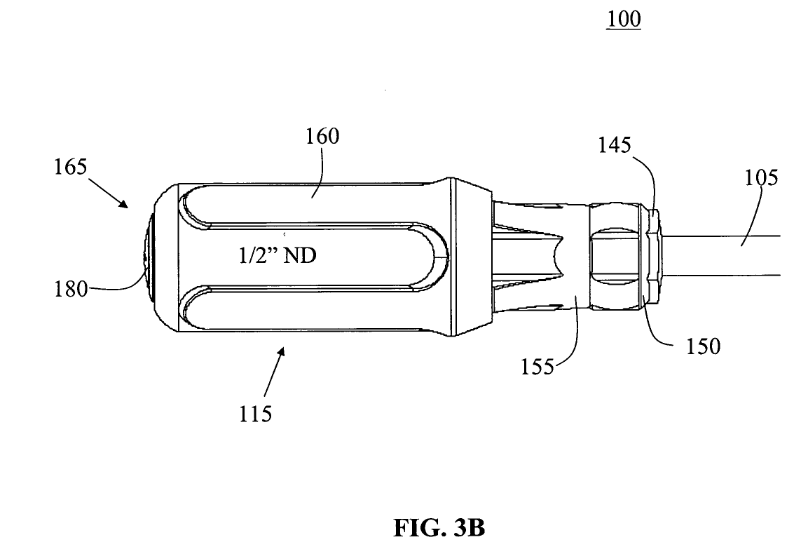

Shaft 105 may also incorporate wrench flats formed on exterior surfaces of shaft 105 so that nut driver 100 can be engaged and rotated by a wrench. In this embodiment, an aperture 130, located within driving portion 110, may be configured so that driving portion 110 engages a nut or head without engaging the corners of the nut/head. Shaft 105 may also have a size and/or type indication on its surface, which indicates the size and/or type of nut driver 100, i.e., the size and/or type of fastener for which nut driver 100 is compatible. An example of an indication 135 is shown in FIG. 3A. Indication 135 may be any combination of symbols and/or alphanumeric indicators to indicate the type of nut driver, or to provide any other information such as component materials or an identification of a manufacturer. Indication 135 may be roll-stamped or etched on shaft 105, or applied in any other suitable manner.

Driving portion 110 includes aperture 130 having an interior shape that is at least substantially the same as the shape of a compatible nut or of the head of a corresponding bolt or other fastener (not shown). Aperture 130 may have any shape suitable to engage a fastener having a given head shape. In one embodiment, aperture 130 may have the shape of a polygon having any suitable number of sides and corners. In another embodiment, shown in FIGS. 1-3 and 7, aperture 130 has the shape of a hexagon having six sides and six corners. Driving portion 110 may simply include an aperture located within shaft 105, or may include an aperture and a socket head having a radius greater than shaft 105, as shown in FIG. 1.

In one embodiment, the interior shape of aperture 130 is determined from a shape of aperture 130 in a plane perpendicular to an axis of rotation of shaft 105 and of nut driver 100. At any rotational position, the shape of aperture 130 has an orientation about the rotational axis. This orientation may be considered an angular position of any feature of the interior shape of aperture 130 about the axis of rotation.

Driving portion 110 is preferably forged or otherwise manufactured from a metal or metal alloy. Driving portion 110 may be a separate component that is welded or otherwise fixedly secured to shaft 105, or may be manufactured as part of shaft 105. In another embodiment, driving portion 110 is made of a harder material than is shaft 105 and/or is coated with a hardness coating such as titanium nitride (TiN) to increase the durability and wear resistance of nut driver 100 and particularly of aperture 130.

As shown in FIG. 1, driving portion 110 may include one or more orientation indicators 140 that visually indicate to a user the orientation of the aperture 130. FIG. 1 shows a plurality of exemplary indicators 140 in the form of recessed or ground channels located on an exterior surface of driving portion 110. Each indicator 140 provides a visual and/or tactile indication of the location of a corner of aperture 130. When engaging a fastener such as a bolt, a user can rotate nut driver 100 until indicators 140 line up with the corners of the bolt head. Each indicator 140 may be in any form sufficient to provide a user with an indication of the orientation of driving portion 110. For example, each indicator 140 may be a recessed portion or a raised protrusion, which would provide the user with a visual and tactile indication of the orientation of driving portion 110. Any other visual markings such as a differently colored region may also be used as indicators 140. In another embodiment, driving portion 110 forms a socket head around aperture 130 and has an outer surface that defines a plurality of corners and sides positioned in the same orientation as the corners and sides of the interior shape of aperture 130.

Nut driver 100 includes a tactile feel indicator 145 that serves to indicate the orientation of aperture 130. Tactile feel indicator 145 allows a user to feel the orientation of aperture 130 by feeling the shape of tactile feel indicator 145. Tactile feel indicator 145 is advantageous over visual indicators on the handle butt, for example, which would be typically covered by the hand and thus be rendered useless while nut driver 100 is used. Tactile feel indicator 145 is also advantageous in that it is less susceptible to wearing off, or to being obscured by dirt and grime, than are such visual indicators.

In the present embodiment, tactile feel indicator 145 is a raised portion, preferably located on or proximate to handle 115. Tactile feel indicator 145 may be part of a monolithic handle, integrated into handle 115, or may be a separate component located proximate or adjacent to handle 115. In one embodiment, tactile feel indicator has a shape that protrudes from a surface of handle 115 or that protrudes from a component adjacent to handle 115. For example, as shown in FIG. 1, tactile feel indicator 145 extends from a handle component 150 in a direction at least substantially parallel to the axis of rotation of nut driver 100. In the embodiment shown in FIG. 1, tactile feel indicator 145 is located on handle 115, closest to shaft 105, and opposite to butt end portion 165. Component 150 may be adhered to handle 115 or may be held adjacent to handle 115 upon assembly of nut driver 100. Tactile feel indicator 145 may alternatively be part of a single monolithic component making up handle 115.

Tactile feel indicator 145 has a shape corresponding to or substantially the same as an interior shape of aperture 130. Tactile feel indicator 145 also has at least substantially the same orientation as the shape of aperture 130. In one embodiment, the shapes of both tactile feel indicator 145 and aperture 130 are determined in a plane that is at least substantially perpendicular to an axis of rotation of shaft 105 and of nut driver 100. At any rotational position, both the shape of tactile feel indicator 145 and the shape of aperture 130 have an orientation about the rotational axis. This orientation may be considered an angular position of any feature of the interior shape of aperture 130 or of tactile feel indicator 145 about the axis of rotation.

Preferably, tactile feel indicator 145 has a shape that is proportional to the interior shape of aperture 130, and has substantially the same orientation as the interior shape of aperture 130. In one embodiment, both tactile feel indicator 145 and aperture 130 may have the shape of a polygon having any suitable number of sides and corner. In the embodiment shown in FIGS. 1-3 and 7, both tactile feel indicator 145 and aperture 130 have the shape of a hexagon having six sides and six corners. Regardless of the number of corners, the corners of tactile feel indicator 145 have at least substantially the same angular position, i.e., angular or circumferential location, about the axis of rotation as do the corners of aperture 130. Thus, tactile feel indicator 145 has a shape that is oriented substantially the same, i.e., is aligned with, the interior shape of aperture 130. Tactile feel indicator 145 also has the benefit of providing to the user both a visual and tactile indication of the shape of nut driver 100.

In another embodiment, tactile feel indicator 145 includes one or more protrusions or other tactile indicators on, for example, handle component 150 that correspond to corners or other features of the internal shape of aperture 130. For example, tactile feel indicator 145 may have a plurality of protrusions, each of which has substantially the same angular position as a corner of the internal shape of aperture 130.

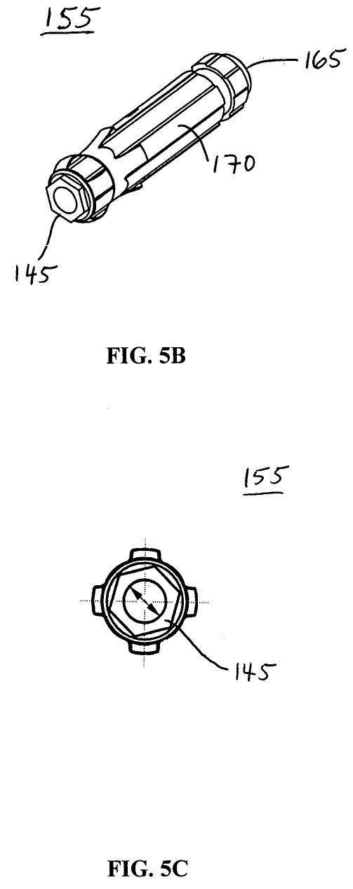

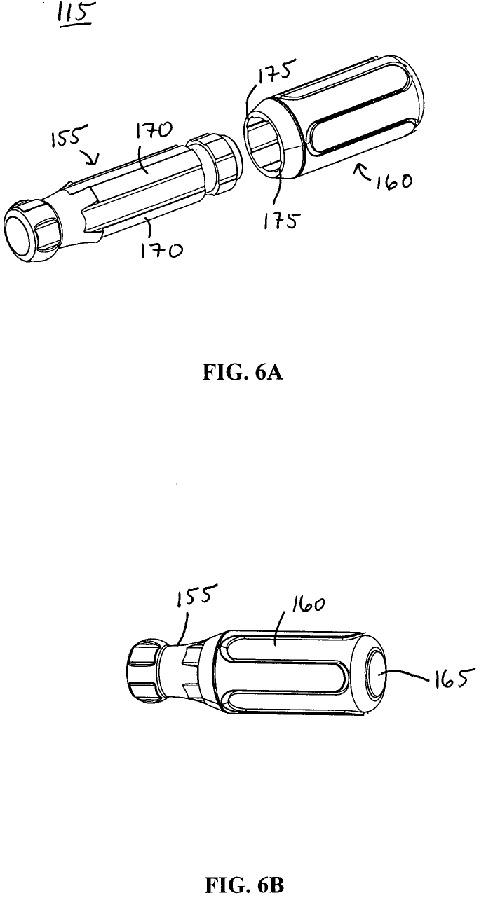

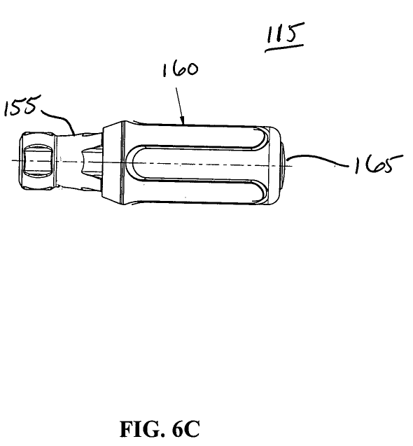

In one embodiment shown in FIGS. 5A-5C and FIGS. 6A-6C, handle 115 includes an interior portion 155, such as a sleeve, and a gripping portion 160. Interior portion 155, shown in FIGS. 5A and 5B, is at least partially hollow at one end to accommodate shaft 105, and has a butt end portion 165 at the opposite end. End portion 165 may include a visual indication of the type and/or size of nut driver 100, as described below. Interior portion 155 may also include protruding guides 170 that engage recess guides 175 inside gripping portion 160 when interior portion 155 is engaged with gripping portion 160 to assemble handle 115. Interior portion 155 is preferably made from a plastic material.

As shown in FIGS. 5B and 5C, tactile feel indicator 145 is attached or otherwise engaged with interior portion 155. Tactile feel indicator 145 has a hexagonal shape that is proportional to the shape of aperture 130 and whose corners have the same angular position about the rotational axis of nut driver 100 as do the corners of aperture 130. Tactile feel indicator 145 is also preferably made from a plastic material, and may be an integral part of interior portion 155, e.g., molded as a single piece, or may be a separate piece attached or adhered to interior portion 155.

FIGS. 6A-6C show the assembly of handle 115. Gripping portion 160 includes recess guides 175 to facilitate engagement between interior portion 155 and gripping portion 160. Gripping portion 160 is completely hollow, so that when gripping portion 160 is slid over interior portion 155, end portion 165 is exposed out of the rear of handle 115. Gripping portion may have a textured surface, such as a roughened surface or a surface including an array of resilient protrusions, and/or is made from or coated with a rubber-like material to facilitate gripping of handle 115. Alternatively, the entire handle 115 may be molded or otherwise formed as a single piece.

Nut driver 100 may also include visual size and type indicators, located on or near handle 115. Such indicators provide a visual indication of the size and type of nut driver 100 or other tool. The size or type of a tool typically refers to the size or type of fastener with which the tool is compatible.

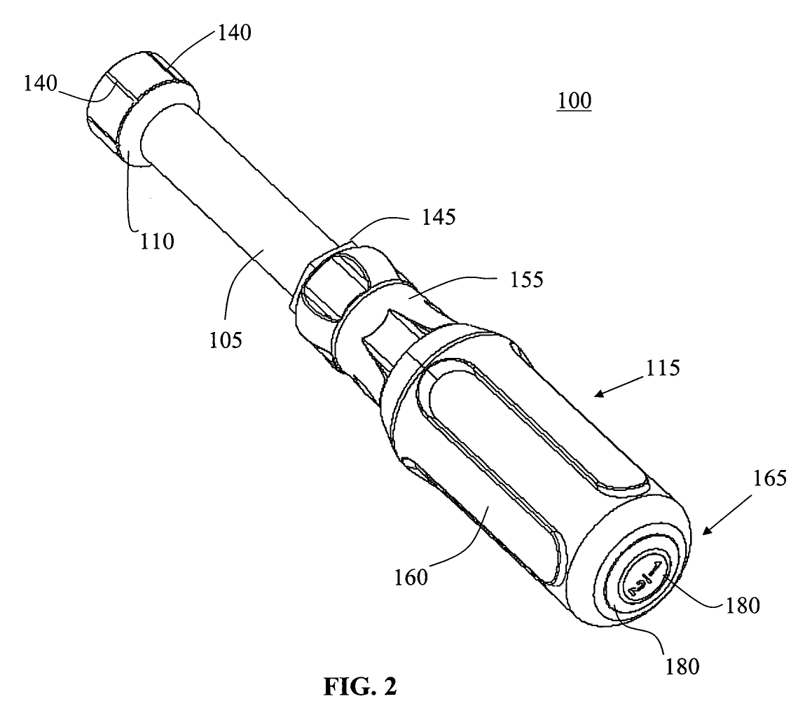

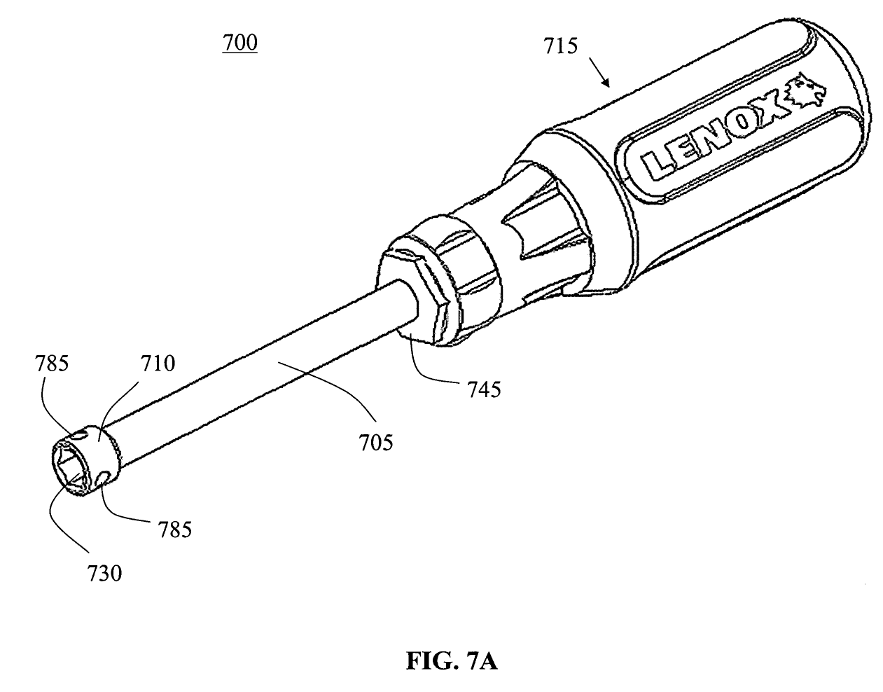

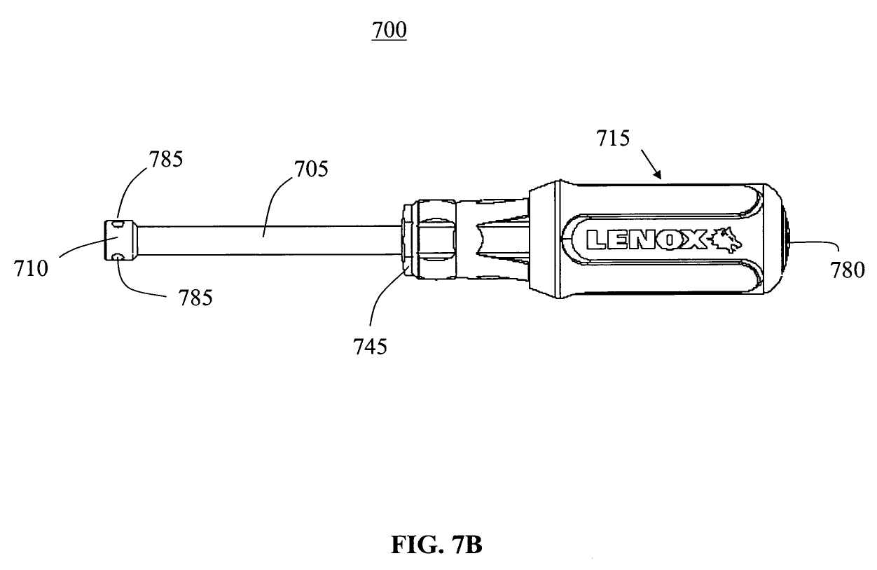

In one embodiment, color-coding may be included on any part of the handle to provide a quick indication of the type or size of the nut driver. In FIG. 1, component 150 and tactile feel indicator 145 may be molded or coated with a color corresponding to a given size or type of nut driver. As shown in FIG. 2, handle 115 may include a colored region 180 on the butt end opposite to the shaft end of handle 115. In one embodiment, colored region 180 is located on end portion 165 of interior portion 155 of handle 115. In another embodiment, shown in FIG. 7, colored regions 780 are placed in various locations on handle 115. Preferably, color-coding is provided in accordance with ASME (American Society of Mechanical Engineers) standards, in which each color designates a different tool head size, and which is hereby incorporated by reference as part of the present disclosure.

In another embodiment, symbols and/or alphanumeric characters may be included on nut driver 100, preferably on handle 115, to indicate the size and/or type of nut driver. As shown in FIG. 2, colored region 180 includes a numeric indicator corresponding to the size of aperture 130 and to the size of a fastener head or nut that can be accommodated by nut driver 100. In the example shown in FIGS. 2 and 3A, “½” designates that nut driver 100 is compatible with ½-inch fasteners. In another embodiment, a symbol may be in the form of a visual representation of the shape of an aperture, such as a hexagon in conjunction with aperture 130.

Referring again to FIGS. 5A-5C, there is provided a method for manufacturing a tool such as nut driver 100. In a first step a central component 156 of interior handle portion 155 is molded to form a single piece including both tactile feel indicator 145 and end portion 165. Central component 156 is molded in a first cavity from a molten material that is preferably colored to indicate a size and/or type of the tool. Central component 156 may be molded with a hollow interior to allow shaft 105 to be later inserted, or may be molded around shaft 105. Central component 156 is preferably formed by injection molding.

In a second step, after central component 156 is formed and sufficiently cool, an outer component 157 having a different color than the central component, is co-molded with central component 156. Co-molding components refers to any method of molding multiple components and incorporating those components into an integral structure. Co-molding may include overmolding outer component 157 to the central component 156, or superimposing outer component 157 over central component 156 and mechanically compressing outer component 157 and central component 156 together. In each case the outer component 157 and central component 156 may be sealed together, such as by mechanical compression. Preferably, outer component 157 is overmolded onto the central component 156. In this process, central component 156 is inserted into a second cavity, and plastic material having a second color, such as white, is injected into the second cavity so that an outer component 157 is formed around the color-coded central component 156. Alternatively, both central component 156 and outer component 157 may be molded in the same cavity using, for example, a rotary injection mold tool. Preferably, both central component 156 and outer component 157 are molded from plastic materials. This method yields interior portion 155 that is substantially white or another desired color(s), with the exception of a color-coded tactile feel indicator 145 and a color-coded end portion 165.

In a third step, interior portion 155 is inserted into gripping portion 160 to complete handle 115. The resultant handle 115 features color coded portions on both ends of handle 115. Shaft 105 may have already been molded into handle 115 during the first step, or may be inserted into handle 115 after the third step to complete the manufacture of nut driver 100. As may be recognized by those of ordinary skill in the pertinent art, the central inner component and outer component in the handle may be over molded or otherwise co-molded in any of numerous different ways that are currently known or that later become known. One advantage of such co-molding method is that the different colored portions are formed at the time of molding, thus forming a durable and long-lasting coloration.

Symbols and/or alphanumeric indicators may be incorporated into the handle by co-molding and overmolding processes similar to those described above. For example, an indicator such as a type/size indicator or a logo is incorporated into handle 115 by first molding the indicator, having a first color, into the desired shape. The remaining handle, or a portion of the handle such as a gripping portion, is molded over/around the indicator using material of a second color, so that one or more surfaces of the indicator are flush with the exterior of the handle. The indicator thus forms the desired symbol and/or alphanumeric indicator on a surface of the handle. Because the indicator is not simply stamped or otherwise printed on the surface of the handle, the indicator formed by this method is very durable and will not rub off over time.

FIGS. 7A and 7B show another embodiment of a nut driver. Magnetic nut driver 700 includes a shaft 705, a socket head or driving portion 710 of shaft 705, and a handle 715. The features of magnetic nut driver 700 are similar to the nut driver 100 with the exception of the features described below, and therefore like reference numerals preceded by the numeral “7” instead of the numeral “1” are used to indicate like elements. Driving portion 710 includes an aperture 730 having an interior hexagonal shape, similar to nut driver 100. Driving portion 710 includes one or more magnets 785 for retaining a nut or bolt head. Magnets 785 are inserted into a hole in driving portion 710 so that a face of each magnet 785 extends at or near an interior surface of aperture 730.

In the example shown in FIGS. 7A and 7B, magnets 785 are disposed in holes located approximately 120° apart about a central longitudinal axis of shaft 705, although magnets 785 may be positioned at various locations in driving portion 710. Magnets 785 may be made from any suitable magnetic material, such as one or more rare earth materials. In the present example, magnets 785 are nickel-plated rare earth magnets.

In one embodiment, magnets 785 are positioned at adjacent faces of hexagonal aperture 730, or are otherwise positioned on any faces of aperture 730 so that magnets 785 are not located directly opposite one another or facing one another. This configuration of magnets 785 will ensure that a fastener having a slotted head, such as a slotted hex screw, will have at least one surface that comes in contact with a magnet 785 when the slotted head is inserted into aperture 730.

The embodiments described above are exemplary, and are not intended to restrict the invention to a nut driver. Various other tools and devices may utilize the features described above, such as sockets or ratchets, shafts for reversible screwdrivers, etc.

As may be recognized by those skilled in the pertinent art based on the teachings herein, numerous changes and modifications may be made to the above-described nut driver, method of making, and exemplary use thereof without departing from the spirit and scope of the invention as defined in the appended claims. For example, nut driver components may be made of any of numerous different materials that are currently known or that later become known for performing the functions of the various components. The nut driver 100, and components thereof, may take any of numerous different configurations that are currently known or that later become known for performing the functions of the different features described herein. Similarly, the nut driver 100 and components thereof may take any of numerous different shapes that are currently or later become known. Further, the socket head aperture can be adapted to receive fasteners and nuts of varying shapes and sizes in both U.S. standard and metric units. Accordingly, this detailed description is to be taken in an illustrative, as opposed to a limiting sense.

1. A device for driving a fastener, comprising:
an elongate shaft having a first end and a second end opposite the first end;
an aperture disposed on the first end and having an interior aperture shape that is substantially the same as a portion of an exterior shape of the fastener, and having a first orientation;
a handle disposed on the shaft; and
a tactile feel element disposed on the shaft having an element shape,
wherein the element shape has a second orientation that is at least substantially the same as an orientation of the interior aperture shape.

2. A device as defined in claim 1, wherein the interior aperture shape is a shape of the aperture in a plane substantially perpendicular to an axis of rotation of the shaft, and the element shape is a shape of the tactile feel element in a plane substantially perpendicular to the axis of rotation.

3. A device as defined in claim 2, wherein the orientation of the interior aperture shape and the element shape is an angular position about the axis of rotation.

4. A device as defined in claim 1, wherein said tactile feel element is selected from the group including: a raised portion of a gripping element, a recessed portion of a gripping element, a textured portion of a gripping element, and any combinations thereof.

5. A device as defined in claim 2, wherein the interior aperture shape includes a plurality of corners and sides, and the element shape includes a plurality of corners and sides.

6. A device as defined in claim 5, wherein the corners of the interior aperture shape have an angular position about the axis of rotation that is substantially equal to an angular position of the corners of the element shape about the axis of rotation.

7. A device as defined in claim 1, wherein the element shape is proportional to the interior aperture shape.

8. A device as defined in claim 7, wherein the tactile feel element and the interior aperture are hexagonally shaped.

9. A device as defined in claim 1, wherein the tactile feel element is at least one of adjacent to and at an end of the handle.

10. A device as defined in claim 1, wherein the tactile feel element is an integral part of the handle.

11. A device as defined in claim 1, further comprising one or more indicators located on an exterior surface of the shaft and proximate to the aperture, to indicate the orientation of the interior aperture shape.

12. A device as defined in claim 11, wherein said one or more indicators are selected from the group including: raised markings, recessed markings, textured markings, colored markings, and any combinations thereof.

13. A device as defined in claim 11, wherein the interior aperture shape includes a plurality of corners and sides positioned on a plane that is substantially perpendicular to an axis of rotation of the shaft, and
wherein the one or more indicators have an angular position about the axis of rotation that is substantially equal to an angular position of at least one of the plurality of corners.

14. A device as defined in claim 5, wherein the shaft forms a socket head around the aperture having an outer surface defining a plurality of corners and sides positioned in the same orientation as the corners and sides of the interior aperture shape.

15. A device as defined in claim 1, wherein the handle comprises a handle sleeve and a handle grip disposed over the handle sleeve, the handle sleeve defining an open end and a butt end.

16. A device as defined in claim 15, further comprising a color code identifier disposed on at least one of the open end and the butt end, indicating the size, shape, or size and shape of a fastener that is compatible with the device.

17. A device as defined in claim 1, further comprising a color code identifier disposed on at least one of the handle and the tactile feel element, indicating the size, shape, or size and shape of a fastener that is compatible with the device.

18. A device as defined in claim 1, further comprising an indicator disposed in the handle, wherein the indicator is co-molded with the handle and visible on a surface of the handle.

19. A device as defined in claim 1, wherein one of the second end of the shaft and the handle defines at least one guide protuberance, and another of the second end of the shaft and the handle defines at least one guide recess for receiving therein the at least one guide protuberance, to substantially prevent relative rotation of the shaft and the handle when the second end of the shaft is received within the shaft opening of the handle.

20. A device as defined in claim 19, wherein the at least one guide protuberance and the at least one guide recess are connectable via a press fit connection.

21. A device as defined in claim 1, farther comprising at least one magnet disposed in a socket head formed around the aperture so that a face of the magnet is located at or near a surface of the aperture.

22. A device as defined in claim 5, further comprising:
a socket head formed around the aperture;
a first magnet disposed in the socket head so that a face of the first magnet is located at or near a surface of a first side of the interior aperture shape; and
a second magnet disposed in the socket head so that a face of the second magnet is located at or near a surface of a second side of the interior aperture shape,
wherein the first side and the second side are not directly opposite each other.

23. A device for driving a fastener, comprising:
an elongate shaft having a first end and a second end;
first means located at the first end of the shaft for engaging a fastener having an exterior shape;
second means located at the second end of the shaft for rotating the device to rotate and drive the fastener; and
third means located at least partially between the first means and the second means for providing a tactile feel indication of an orientation of the first means.

24. A device as defined in claim 23, wherein the first means is an aperture disposed on the first end and having an interior aperture shape that is substantially the same as at least a portion of the exterior shape of the fastener; the second means is a handle; and the third means is a tactile feel element having an element shape that has an orientation that is substantially the same as an orientation of the interior aperture shape.

25. (canceled)

26. (canceled)
